(19) United States
(12) Patent Application Publication
(10) Pub. No.: US 2018/0134233 A1
(43) Pub. Date: May 17, 2018

(54) VEHICLE MOUNTING SYSTEM FOR MOBILE PHONE

(71) Applicant: Sung Bong Kim, Niles, IL (US)

(72) Inventor: Sung Bong Kim, Niles, IL (US)

(21) Appl. No.: 15/354,367

(22) Filed: Nov. 17, 2016

(51) Int. Cl. B60R 11/02; H02J 7/02; H02J 7/14; H02J 7/00

(52) U.S. Cl. CPC B60R 11/0241; H02J 7/025; B60R 2011/0005; H02J 7/0044; H02J 7/14

(57) ABSTRACT

A mounting system for a mobile device such as a mobile phone on a vehicle dashboard is disclosed. The mobile phone is mounted on a surface of the dashboard and includes sun shielding via a built in sun shield which shields a vehicle display in front of the driver, and extends rearward over the mobile phone to sufficiently shield the mobile phone screen when the mobile phone is mounted in the mounting location provided. The mounting allows the mobile device to be tilted to a desired angle, and optionally provides wireless charging circuitry to enable charging of the device while mounted.

### CROSS-REFERENCES

This application claims the benefit of U.S. Provisional Patent Application No. 62/260,519 filed on Nov. 28, 2015, which is hereby incorporated by reference in its entirety.

### BACKGROUND OF THE INVENTION

### Field of the Invention

The present invention relates to a system for mounting a mobile phone device in a vehicle, and more particularly, to a system for mounting a mobile phone on a dashboard with sun shielding.

### Background

Mobile phones have become an integral part of the daily lives of a large portion of the population. Many people keep their mobile phone with them at all times, including while driving. However, most car manufacturers do not provide a designated space for mobile phones in vehicles, or if there is such a designated location, it is insufficient. Thus, many drivers purchase a separate mounting device in order to mount their mobile phone in their vehicle.

These separate mobile phone mounting devices, or brackets, generally include suction cups to be attached to the windshield, or a plate with a sticky gel pad to be secured on top of the dashboard of the vehicles. The mobile phones secured in these conventional manners have a number of following shortcomings.

First, many such mounts are not able to be mounted in a position which is convenient to the driver. Secondly, many such mounts are placed above the dashboard or on the windshield, and they can obstruct the driver's view. Furthermore, many such mounts cause vehicle controls, gauges, or vents to be blocked by the mounting. Most importantly, conventional mounts lack any sufficient shielding from sunlight, and thus, under many lighting situations, the screen becomes unreadable.

In one convention example, U.S. Pat. No. 7,469,951 issued to Welschholz et al., discloses a mounting system for a mobile device on a vehicle dash board. The mounting system provides no shielding from the sun, and thus, would be difficult to see under various lighting conditions.

While various other devices have been proposed, there remains a need for a mobile phone mounting system which is conveniently located and provides sufficient shielding from sunlight, among other advantages.

### SUMMARY

The present invention is a mobile phone mounting system on a vehicle dashboard. The mounting system enables a mobile phone to be mounted conveniently, located close to the driver, on a surface of the dashboard without obstructing the driver's view through the windshield of the vehicle.

A mounting location is provided on the dashboard of a vehicle so that a mobile phone may be mounted without interfering with any gauges, controls, vents, or other functionality. Most importantly, the mounting location is positioned such that a sun shield built into the dashboard which is already present to shield a portion of the dashboard in front of the driver extends over the mounting location and provides sufficient sun shielding to enable the screen of the mobile phone to be viewable in bright sunlight and a variety of lighting conditions.

The mounting system includes a rotatable joint to allow the mobile phone to be positioned at a desirable angle. It may be attached via any suitable means, such as a sticky gel pad, suction cup, or mechanical mounting hardware.

In various embodiments, the mounting system includes wireless charging circuitry to enable wireless charging of a mobile phone while the mobile phone is mounted.

Still other objects and advantages of the present invention will become readily apparent to those skilled in the art from the following detailed description, wherein it is shown and described only the preferred embodiments of the invention, simply by way of illustration of the best mode contemplated of carrying out the invention. As will be realized, the invention is capable of other and different embodiments and its several details are capable of modifications in various obvious respects, without departing from the invention. Accordingly, the drawings, wherein like reference numerals represent like features, and description are to be regarded as illustrative in nature and not as restrictive.

### BRIEF DESCRIPTION OF THE DRAWINGS

FIG. 1 illustrates a front view of a vehicle dashboard showing the mounting system in accordance with one embodiment of the present invention.

FIG. 2 illustrates a simplified cross sectional view taken along the line 2-2 of FIG. 1.

FIG. 3 illustrates a simplified cross sectional view taken along the line 3-3 of FIG. 4 after the mobile phone mounting bracket is installed and the mobile phone is placed in the bracket, in accordance with one embodiment of the present invention.

FIG. 4 illustrates a front view of a vehicle dashboard in accordance with one embodiment of the present invention after the mobile phone is placed in its mounting bracket.

FIG. 5 illustrates the mobile phone mounting bracket mechanically secured in the front surface of the vehicle dashboard by a base and a securing nut, in accordance with one embodiment of the present invention.

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

In various embodiments, the present invention is a mounting system for a mobile electronic device, such as a mobile phone, in a vehicle. The mounting system includes a vehicle dashboard having a substantially flat front surface. A sun shield extending above and outward, toward the rear of the vehicle, from the front surface is provided to shield the viewing screen from sunlight. This sun shield is ideally the sun shield built into the vehicle which is already present to shield various gauges on the dashboard in front of the driver.

In certain embodiments, a mounting area on the front surface free of unrelated controls, devices, vents, and gauges adapted to receive a mobile electronic device mounting member is provided. The mounting area is shielded under the sun shield to an extent that at least half of a viewing screen of such an electronic mobile device is shielded by the sun shield when sunlight enters the vehicle at an angle between 0 and 45 degrees from vertical. Thus, the screen of the device is shielded under a great variety of lighting conditions.

In various embodiments, the mounting system includes charging circuitry adapted to charge such a mobile electronic device. The charging circuitry may be adapted for wired, or ideally, wireless charging of the mobile phone. Thus, a mobile phone or other device may be charged while mounted in the vehicle, preferably without the need for a wired connection.

In certain embodiments, a mounting base apparatus adapted to receive such a mobile electronic device is provided having a mounting member adapted to mount to the mounting area. The mounting base apparatus preferably includes a rotatable joint adapted to enable a user to adjust a viewing angle with respect to such a mobile electronic device. In certain embodiments, this joint is a ball joint.

The mounting member may be any suitable mounting means. In various embodiments, the mounting member may be a suction cup, adhesive element such as a sticky gel pad, hook and loop fastener element, magnet, or mounting hardware such as a nut, screw, bolt, or other suitable mounting hardware.

The present invention also includes a method for mounting a mobile electronic device to a vehicle dashboard. The method includes the steps of mounting a mobile electronic device to a mounting area of a vehicle dashboard, wherein the mounting area is a section of a dashboard free of controls and gauges, and wherein the mounting area is shielded via a sun shield extending above and outward from a top portion of the vehicle dashboard.

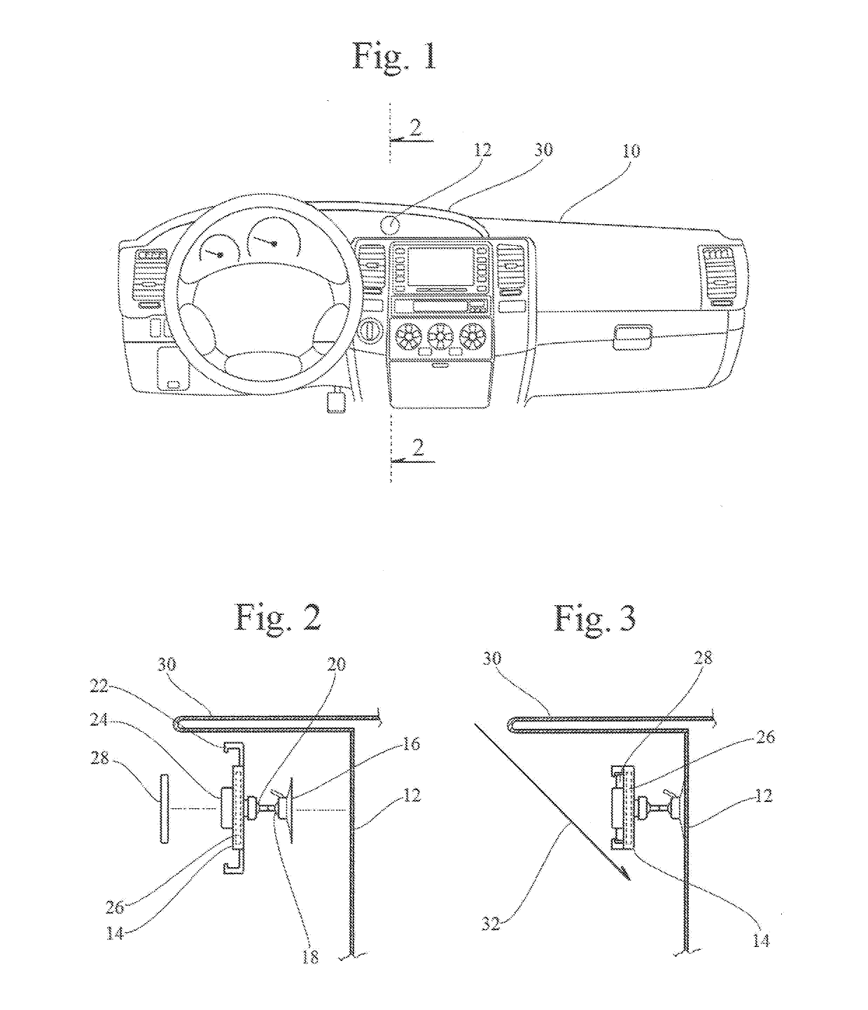

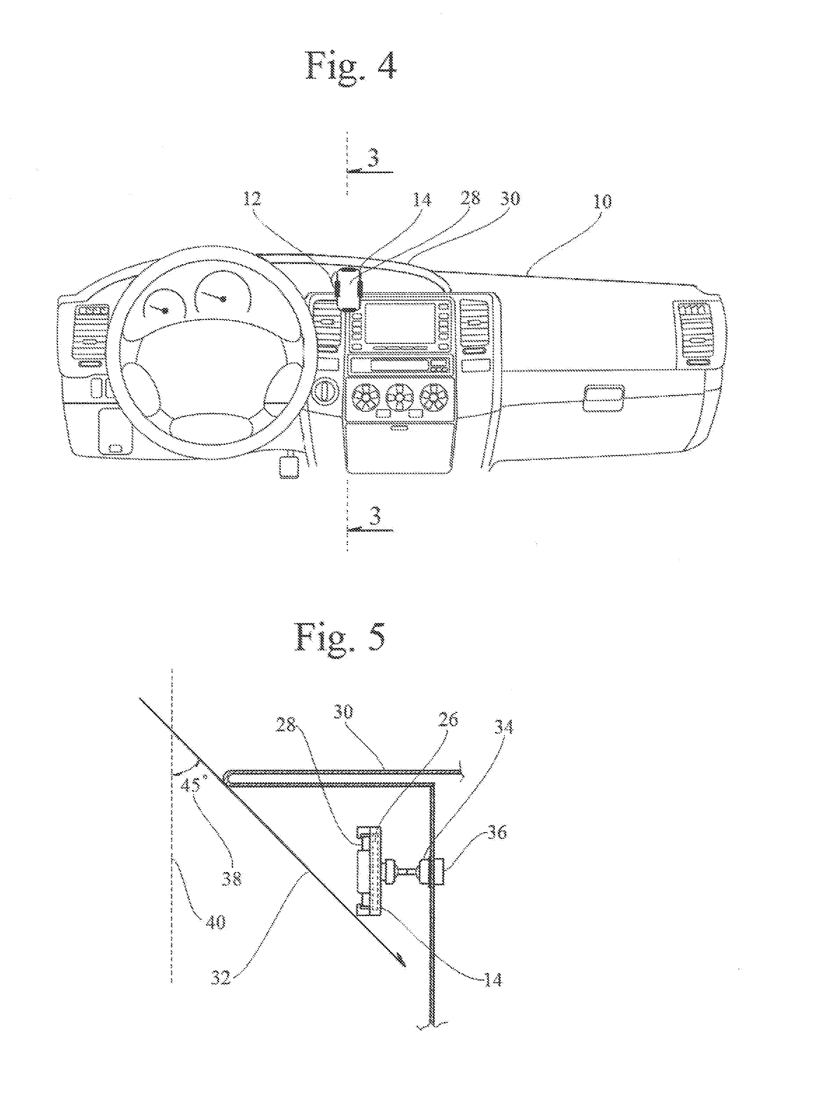

With reference to the drawings, various embodiments of the present invention include but are not limited to the following descriptions of the present invention. A preferred design of the dashboard in accordance with the present invention is shown in FIG. 1 with the dashboard shown with a general reference number 10. The mobile phone mounting bracket is rotatably secured at a convenient place 12 in the front surface of the dashboard 10 in the manner described below.

FIG. 2 illustrates a simplified cross sectional view taken along the line 2-2 of FIG. 1. In certain preferred embodiments of the present invention, the mobile phone mounting bracket 14 comprises a suction cup or a sticky gel pad 16, a first rotatable joint 18 and a second rotatable joint 20. The suction cup or a sticky gel pad 16 sticks to a smooth and relatively flat surface 12 in the front of the dashboard. The first rotatable joint 18 and the second rotatable joint 20 together provide the driver freedom to move the mobile phone mounting bracket 14 to the most convenient place and angle to see its screen. In certain embodiments, a single rotatable joint is sufficient.

The mobile phone mounting bracket 14 further comprises a first pair of adjustable flaps 22, a second pair of adjustable flaps 24, and optional wired, or preferably wireless, charging circuitry 26. The mobile phone 28 is to be placed in the conventional manner inside these first adjustable flaps 22 and the second adjustable flaps 24. The optional wireless charging circuitry 26 can be installed in the mobile phone mounting bracket 14 to automatically charge the mobile phone 28 when it is in its place. There are a number of different ways to design and construct rotatable joints, adjustable flaps, and the wired, or preferably wireless, charging circuitry known in the industry.

As shown in FIG. 1 and FIG. 3, a protruding cover 30 extends toward the driver at the top of the dash board 10 to provide a shield to the screen of the mobile phone 28 from the incoming sunlight 32 when the driver is using the navigation system or checking incoming calls on the mobile phone 28.

In various preferred embodiments of the present invention, the top cover 30 extends toward the rear of the vehicle far enough to block the sunlight 32 from reaching at least a half of the viewing screen of a mobile phone 14 when sunlight enters the vehicle at an angle between 0 and 45 degrees 38 from the vertical 40. In certain embodiments, sunlight is blocked by the sun shield from reaching the entire viewing screen of a mobile phone when sunlight enters the vehicle at an angle between 0 and 45 degrees 38 from the vertical 40.

As shown in FIG. 5, the mobile phone mounting bracket 14 can also be attached to the front surface 12 by a securing nut 34 and a mounting base 36. In case the driver prefers not to have the mobile phone mounting bracket 14 attached to the front surface 12 of the dashboard 10, the driver can easily remove it from the vehicle by loosening and detaching the securing nut 34 from the mounting base 36.

While specific embodiments have been illustrated and described, numerous modifications come to mind without significantly departing from the spirit of the invention and the scope of protection is limited by the scope of the accompanying claims.

What is claimed is:

1. A mounting system for a mobile electronic device in a vehicle comprising:
a dashboard having a substantially flat front surface,
a sun shield extending above and outward toward a rear end of such a vehicle from said front surface,
a mounting area on said front surface free of unrelated controls, devices, vents, and gauges adapted to receive a mobile electronic device mounting member, wherein said mounting area is shielded under said sun shield to an extent that at least half of a viewing screen of such an electronic mobile device is shielded by said sun shield when sunlight enters the vehicle at an angle between 0 and 45 degrees from vertical.

2. The mounting system for a mobile electronic device according to claim 1, wherein said mounting area includes wireless charging circuitry adapted to wirelessly charge such a mobile electronic device, and wherein such a mobile electronic device is a mobile phone.

3. The mounting system for a mobile electronic device according to claim 1, further comprising a mounting base apparatus adapted to receive such a mobile electronic device, said mounting base apparatus having a mounting member adapted to mount to said mounting area.

4. The mounting system for a mobile electronic device according to claim 3, wherein said mounting base apparatus further comprises a rotatable joint adapted to enable a user to adjust a viewing angle with respect to such a mobile electronic device.

5. The mounting system for a mobile electronic device according to claim 4, wherein said rotatable joint is a ball joint.

6. The mounting system for a mobile electronic device according to claim 3, wherein said mounting member comprises a suction cup adapted to attach to said mounting area.

7. The mounting system for a mobile electronic device according to claim 3, wherein said mounting member comprises an adhesive element adapted to attach to said mounting area.

8. The mounting system for a mobile electronic device according to claim 3, wherein said mounting member comprises a nut, screw, or bolt adapted to attach to said mounting area.

9. The mounting system for a mobile electronic device according to claim 3, wherein said mounting member comprises hook and loop fastener element adapted to attach to said mounting area.

10. The mounting system for a mobile electronic device according to claim 3, wherein said mounting member comprises a magnet adapted to attach to said mounting area.

11. A method for mounting a mobile electronic device to a vehicle dashboard comprising the steps of:
mounting a mobile electronic device to a mounting area of a vehicle dashboard, wherein said mounting area is a section of a dashboard free of controls and gauges, and wherein said mounting area is shielded via a sun shield extending above and outward toward a rear end of such a vehicle from a top portion of the vehicle dashboard.
